(19) United States
(12) Patent Application Publication
(10) Pub. No.: US 2025/0164694 A1
(43) Pub. Date: May 22, 2025

(54) BEAM SPLITTING AND COMBINING MICRO-OPTIC

(71) Applicant: Lumentum Technology (UK) Limited, NORTHAMPTONSHIRE (GB)

(72) Inventors: Samuel Justin JONES, Paignton (GB); David DAVIES, Torquay (GB); Colin SMITH, Paignton (GB)

(21) Appl. No.: 18/403,337

(22) Filed: Jan. 3, 2024

Related U.S. Application Data
(60) Provisional application No. 63/600,249, filed on Nov. 17, 2023.

(51) Int. Cl. G02B 6/27

(52) U.S. Cl. CPC G02B 6/2726; G02B 6/2773

(57) ABSTRACT

In some implementations, an optical device includes a plurality of optically bonded optical elements that form a single monolithic optical component, wherein the plurality of optically bonded optical elements comprises: a set of optical splitter surfaces configured to optically split a first input beam into a plurality of first output beams; and a set of optical combiner surfaces configured to optically combine a plurality of second input beams into one or more second output beams, wherein a set of optical paths coupling a set of inputs, to receive the first input beam and the plurality of second input beams, and the set of outputs, to output the plurality of first output beams and the one or more second output beams, are formed by the single monolithic optical component without an intermediate air interface.

### CROSS-REFERENCE TO RELATED APPLICATION

This patent application claims priority to U.S. Provisional Patent Application No. 63/600,249, filed on Nov. 17, 2023, and entitled “MICRO-OPTICS FOR BEAM SPLITTING AND COMBINING.” The disclosure of the prior application is considered part of and is incorporated by reference into this patent application.

### TECHNICAL FIELD

The present disclosure relates generally to optical devices and to a beam splitting and beam combining micro-optic.

### BACKGROUND

An optical system may include at least one optical element. For example, an optical system may include a beamsplitter to divide a beam into multiple portions. In this case, the beamsplitter may direct portions of a beam into a first optical path and a second optical path. Another optical system may include a beam combiner to combine multiple beams into a single beam. In this case, the beam combiner may direct a first beam and a second beam along a single optical path as a single beam. Beamsplitters and beam combiners may be implemented using photonic integrated circuits (PICs) or planar lightwave circuit (PLCs). A PIC may include electro-optical component that includes a microchip with a set of photonic components. A PLC may include an electro-optical component that includes a set of waveguides disposed on a substrate.

### SUMMARY

In some implementations, an optical device includes a plurality of optically bonded optical elements that form a single monolithic optical component, wherein the plurality of optically bonded optical elements comprises: a set of optical splitter surfaces configured to optically split a first input beam into a plurality of first output beams; and a set of optical combiner surfaces configured to optically combine a plurality of second input beams into one or more second output beams, wherein a set of optical paths coupling a set of inputs, to receive the first input beam and the plurality of second input beams, and the set of outputs, to output the plurality of first output beams and the one or more second output beam, are formed by the single monolithic optical component without an intermediate air interface.

In some implementations, an optical device includes a plurality of optically bonded optical elements comprising: a first set of optical elements to optically split a first one or more beams, wherein the first set of optical elements includes at least one splitting surface and at least one reflecting surface; and a second set of optical elements to optically combine a second one or more beams, a set of inputs; and a set of outputs, wherein the set of inputs are coupled to the set of outputs via the first set of optical elements and the second set of optical elements.

In some implementations, an optical device includes a plurality of optically bonded optical elements that form a single monolithic optical component, wherein the plurality of optically bonded optical elements comprises: a set of optical splitter surfaces configured to optically split a first input beam into a plurality of first output beams, wherein the set of optical splitter surfaces are formed on a first subset of optically bonded optical elements of the plurality of optically bonded optical elements, wherein the set of optical splitter surfaces includes at least one splitting surface and at least one first reflecting surface; and a set of optical combiner surfaces configured to optically combine a second input beam and a third input beam into a single second output beam, wherein the set of optical combiner surfaces are formed on a second subset of optically bonded optical elements of the plurality of optically bonded optical elements, wherein the set of optical combiner surfaces includes at least one polarization multiplexing surface and at least one second reflecting surface, wherein the plurality of optically bonded optical elements includes a set of inputs and a set of outputs, wherein a set of optical paths coupling the set of inputs and the set of outputs are formed by the single monolithic optical component without an intermediate air interface.

### BRIEF DESCRIPTION OF THE DRAWINGS

FIG. 1 is a diagram of optical paths of an example optical device associated with beam splitting and combining micro-optic.

FIGS. 2A-2C are diagrams of an example optical device associated with beam splitting and combining micro-optic.

FIG. 3 is a diagram of an example optical system associated with beam splitting and combining micro-optic.

FIG. 4 is a diagram of an example optical system associated with beam splitting and combining micro-optic.

### DETAILED DESCRIPTION

The following detailed description of example implementations refers to the accompanying drawings. The same reference numbers in different drawings may identify the same or similar elements.

An optical system may include multiple optical elements to perform multiple optical functions within the optical system. For example, an optical system may include one or more optical splitters, one or more optical combiners, one or more polarization dependent reflectors (e.g., that may perform a multiplexing function as one or more polarization multiplexers), or one or more reflectors, among other examples. In a transmitter-receiver optical subassembly (TROSA), micro-optics may be used to perform functions of the TROSA. For example, a set of photonic integrated circuits (PICs) or planar lightwave circuits (PLCs) may be used to perform splitting and combining for sampling a beam and/or splitting and combining for controlling a direction of different polarization states of the beam. A PIC or a PLC may be associated with one or more optical lenses to adjust a size of a beam, which is propagating in free space, and couple the beam into a waveguide mode of the PIC or the PLC. However, incorporating a set of lenses into an optical system may result in an excessive use of available space, thereby preventing miniaturization of the optical system. Furthermore, using a PIC or a PLC may result in a propagation loss across a length of the PIC or a PLC, which may result in poor performance for an optical system.

Alternatively, some optical systems may use multiple discrete free-space optics to perform multiple functions. For example, an optical system may include a first optical element that performs a first optical function (e.g., combining) and a second optical element that performs a second optical function (e.g., reflecting). However, as a quantity of optical functions that are to be performed increases, multiple discrete free-space optics may not fit in an available package. Additionally, or alternatively, a level of alignment tolerance that is achievable with multiple free-space optics using, for example, a pick-and-place machine may not satisfy an alignment criterion for an optical system. This may result in poor optical coupling, which may result in poor optical performance (e.g., excessive noise, power loss, or cross-talk). Further, using multiple discrete free-space optics may result in a high level of insertion loss associated with each air-glass interface of each free-space optic.

Some implementations described herein provide a multi-function micro-optic. For example, an optical device may include multiple optically bonded optical elements that form a single monolithic optical component. The multiple optically bonded optical elements may include patterned surfaces that perform multiple optical functions, such as optical beam splitting and optical beam combining. For example, a single monolithic optical component may split an input beam and combine multiple output beams. By integrating multiple optically bonded optical elements, the optical device avoids insertion loss by minimizing air-glass interfaces being each optical element. Additionally, or alternatively, a procedure for optically bonding the optical elements, such as a cutting, etching, or patterning procedure, among other examples, may achieve a higher level of alignment tolerance than is achieved when positioning discrete optics in free space, thereby improving optical performance of the optical device relative to a free-space optics system. Additionally, or alternatively, by using the multiple optically bonded optical elements, the optical device may reduce propagation loss relative to use of a PIC or PLC and may obviate a need for lensing to couple in or out a beam for splitting or combining. This may enable improved miniaturization relative to PICS, PLCs, and free-space optics. Additionally, or alternatively, by using multiple optically bonded optical elements, the optical device may achieve a reduced amount of loss and improved polarization performance.

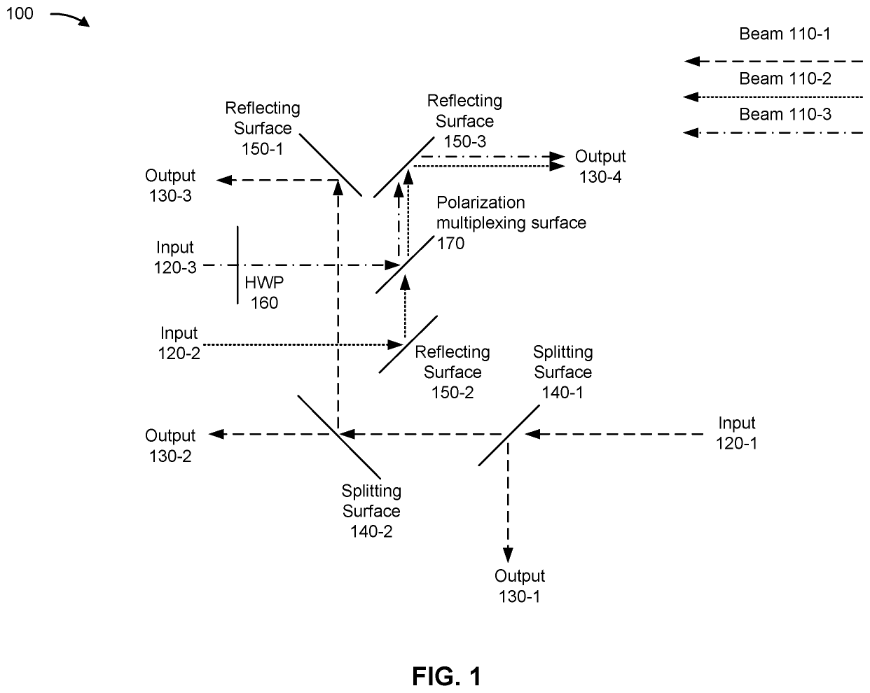

FIG. 1 is a diagram of optical paths of an example optical device 100 associated with beam splitting and combining micro-optic. As shown in FIG. 1, example optical device 100 includes a set of optical paths traversed by a set of optical beams 110. In some implementations, the set of optical beams 110 may include linearly polarized coherent light from a light source (e.g., a laser emitter). In some implementations, the set of optical beams 110 may have a relatively high degree of polarization alignment. For example, each optical beam 110 may have a polarization aligned to within a 5% or 1% tolerance of each other.

As further shown in FIG. 1, the optical beam 110-1 is directed along an optical path from an input 120-1 to a splitting surface 140-1. The optical beam 110-1 is split into a first portion that is directed toward an output 130-1 and a second portion that is directed toward a splitting surface 140-2. The second portion of the optical beam 110-1 is split, by the splitting surface 140-2, into a first sub-portion that is directed to an output 130-2 and a second sub-portion that is directed to a reflecting surface 150-1, which uses total internal reflection to reflect the second sub-portion toward an output 130-3. In some implementations, the splitting surfaces 140 may have a configured splitting ratio. For example, the splitting surface 140-1 may split the optical beam 110-1, such that 25% of light is reflected and 75% of light is passed through. Similarly, the splitting surface 140-2 may split the second portion of the optical beam 110-1, such that 66.6% of the second portion is reflected and 33.3% of the second portion is passed through.

A first optical path may include the optical beam 110-1 being directed from the input 120-1 to the output 130-1 via the splitting surface 140-1. A second optical path may include the optical beam 110-1 being directed from the input 120-1 to the output 130-2 via the splitting surface 140-1 and the splitting surface 140-2. A third optical path may include the optical beam 110-1 being directed from the input 120-1 to the output 130-3 via the splitting surface 140-1, the splitting surface 140-2, and the reflecting surface 150-1. In this case, the optical beam 110-1 is received at a single input of the optical device 100 as a single input beam and is split into three output beams at three outputs of the optical device 100.

As further shown in FIG. 1, the optical beam 110-2 is directed along an optical path from an input 120-2 to a reflecting surface 150-2 and reflecting toward a polarization multiplexing surface 170. Similarly, the optical beam 110-3 is directed along an optical path from an input 120-3 to a half waveplate (HWP) 160 and to the polarization multiplexing surface 170. At the HWP 160, the optical beam 110-3 is rotated from a first polarization orientation to a second polarization orientation. For example, the optical beam 110-3 may be rotated such that the second polarization orientation of the optical beam 110-3 is orthogonal to a third polarization orientation of the optical beam 110-2. In other words, the optical beams 110-2 and 110-3 may enter the inputs 120-2 and 120-3, respectively, at the same polarization orientation, but the optical beam 110-3 may be rotated by the HWP 160 to be orthogonal to the optical beam 110-2. At the polarization multiplexing surface 170, the optical beam 110-2 is multiplexed with the optical beam 110-3 (e.g., at orthogonal polarization orientations) and directed toward the reflecting surface 150-3. The reflecting surface 150-3 may direct the multiplexed optical beams 110-2 and 110-3 to an output 130-4. A fourth optical path may include the optical beam 110-2 being directed from the input 120-2 to the output 130-4 via the reflecting surface 150-2, the polarization multiplexing surface 170, and the reflecting surface 150-3. A fifth optical path may include the optical beam 110-3 being directed from the input 120-3 to the output 130-4 via the HWP 160, the polarization multiplexing surface 170, and the reflecting surface 150-3. As shown in FIG. 1, the five optical paths (e.g., three optical inputs being optically coupled to 4 optical outputs) are provided as an example. Other quantities or arrangements of optical paths, optical inputs, and/or optical outputs are contemplated.

As indicated above, FIG. 1 is provided as an example. Other examples may differ from what is described with regard to FIG. 1. The number and arrangement of elements shown in FIG. 1 are provided as an example.

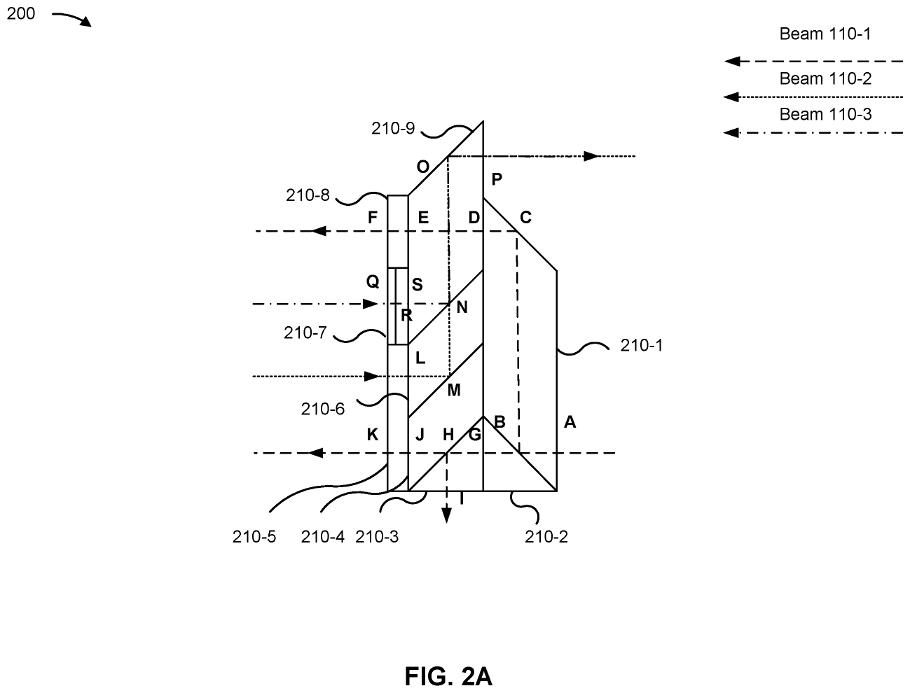

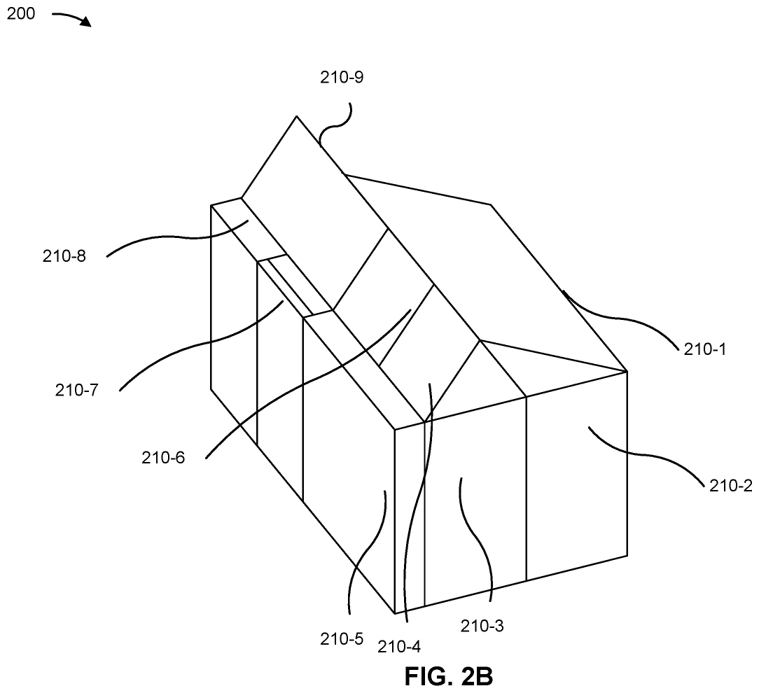

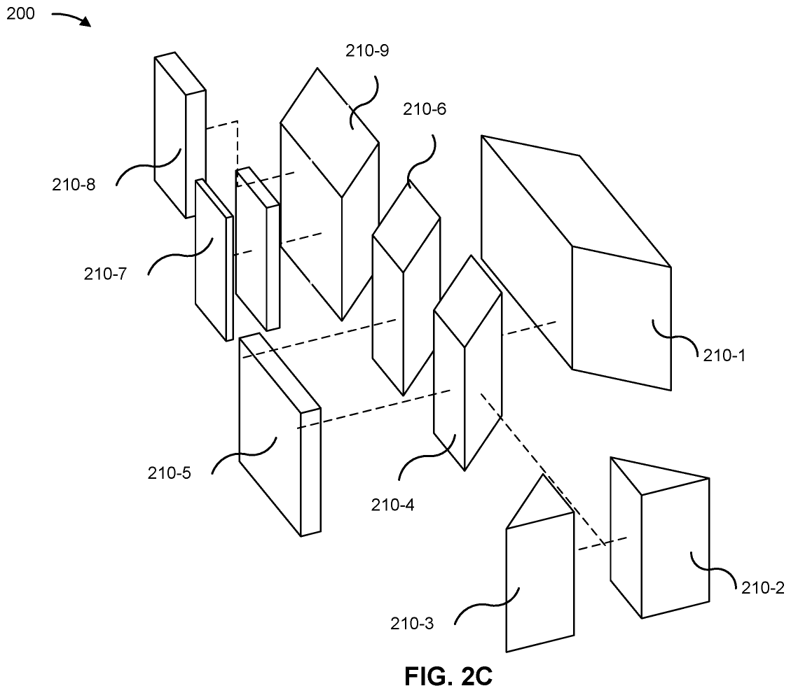

FIGS. 2A-2C are diagrams of an example optical device 200 associated with beam splitting and combining micro-optic. As shown in FIGS. 2A-2C, optical device 200 includes a set of optical elements 210-1 through 210-9. FIG. 2A shows a top-down view of the set of optical elements 210. FIG. 2B shows a three-dimensional projection view of the set of optical elements 210. FIG. 2C shows an exploded view of the set of optical elements 210.

As further shown in FIG. 2A, the set of optical elements 210 are optically bonded to form the optical device 200. For example, each optical element 210 is optically bonded to at least one other optical element 210 to form a set of optical paths for the optical beams 110. An optical bonding may include a glass-to-glass bonding procedure that forms a single discrete optical element out of multiple discrete optical elements. In other words, by bonding two optical elements 210 with the same refractive index (or similar refractive indices), an optical beam can pass through the interface of the two optical elements 210 without experiencing a level of insertion loss associated with being directed from a first optical element to an air interface (e.g., free space propagation) to a second optical element (e.g., a glass-to-air-to-glass propagation). In some implementations, each optical element 210 is a glass prism. For example, each optical element 210 may be a glass prism manufactured or cut from a glass die and some of the optical elements 210 may have patterned, etched, or otherwise manipulated surfaces to achieve an optical function. Additionally, or alternatively, a size or an orientation of an optical element 210 (e.g., relative to other optical elements 210 or the set of optical paths) may be selected to achieve an optical function. As an example, an optical element 210 may include a surface that performs an optical function, such as an anti-reflectance (AR) function, a polarization rotation function, a reflection function, a multiplexing function, a splitting function, or a combining function, among other examples.

As shown in FIG. 2, the optical element 210-1 may receive an input of optical beam 110-1 at a surface A, which may have an AR coating to prevent back-reflection of the optical beam 110-1. In some implementations, an optical beam 110, such as the optical beam 110-1, may be incident at a particular incidence angle. For example, the optical beam 110-1 may be incident at a 1 degree incident angle (e.g., offset from normal) to reduce back reflection from AR coated surfaces propagating coaxially in a reverse direction of the optical beam 110-1.

The optical beam 110-1 may propagate to the surface B at the interface of the optical element 210-1 and the optical element 210-2, which may split the optical beam 110-1 into a first portion that is reflected up toward surface C (e.g., a reflecting surface) and through surface D, E, and F, where the first portion exits the optical device 100. In some implementations, the surface F (or another output) may have an AR coating to reduce insertion loss at the output. In some implementations, the optical element 210-8 (and the surface F) are provided in the optical device 200 to improve manufacturability and to satisfy beam parallelism tolerances. Similarly, the optical element 210-6 may be a glass plate that provides an AR coating, improves manufacturability, and satisfies beam parallelism tolerances. The surface B at the interface of the optical element 210-1 may pass through a second portion of the optical beam 110-1 toward surface G and surface H, which splits the optical beam 110-1 into a first sub-portion propagated to surface I and a second sub-portion propagated to surfaces J and K. The first sub-portion and second sub-portion of the optical beam 110-1 exit the optical device 100 at surfaces I and K, respectively.

As further shown in FIG. 2A, the optical beam 110-2 propagates through surfaces K and L, is reflected by surface M, is multiplexed by surface N, reflects off surface O, and exits the optical device 200 at surface P. The surface M may include a high reflectivity coating or total internal reflection coating or structure to reflect the optical beam 110-2. The surface N may include a polarization dependent coating that passes through p-polarized light (e.g., the optical beam 110-2) and reflects s-polarized light (e.g., the optical beam 110-3, as described below). The surface O may include a total internal reflection coating or structure to reflect the optical beam 110-2 (And the optical beam 110-3, as described below). In some implementations, each optical path of each optical beam 110 may be associated with traversing two AR coatings (e.g., a first AR coating when entering the optical device 200 and a second AR coating when exiting the optical device 200). Additionally, or alternatively, an optical path may be split resulting in traversing two or more AR coatings (e.g., a first AR coating when entering the optical device 200 and multiple second AR coatings when exiting the optical device 200). Additionally, or alternatively, the optical device 200 may be directly connected to one or more other components of an optical system (e.g., a direct input connection and/or a direct output connection), which may obviate a need for one or more AR coatings.

As further shown in FIG. 2A, the optical beam 110-3 propagates through the surface Q, is polarization rotated by an HWP surface R, passes through a surface S, is multiplexed by the surface N, reflects off the surface O, and exits the optical device 200 at the surface P. In some implementations, the HWP surface R is included in the optical element 210-7, which may be a multi-part optical element. For example, the optical element 210-7 may include a first section, shown on the left, which is a glass plate with an AR coating to reduce back reflection, improve manufacturability, and satisfy beam parallelism tolerances. Additionally, the optical element 210-7 may include a second section, shown on the right, which is a HWP for rotating a beam.

The surfaces A through P, among other examples, represent interfaces between or within optical elements 210. For example, the surface B is a reflector surface at a glass-to-glass interface between optical element 210-1 and optical element 210-2. The glass-to-glass interface may be associated with an optical bonding of the optical element 210-1 and the optical element 210-2, which may be manufactured from a common material (or from materials with respective refractive indices that are within a threshold percentage of each other, such as less than 5% difference or less than 1% difference in refractive indices).

In some implementations, a surface, such as the surfaces A through P, which may include an optical splitter surface, an optical combiner surface, an optical reflector surface, or an optical multiplexer surface (e.g., a polarization dependent reflector that is configured for multiplexing), among other examples, are formed by a manufacturing procedure. For examples, an optical element 210 may be subject to a patterning procedure, an etching procedure, a deposition procedure, a thin film manufacturing procedure, or another type of procedure to produce a surface treatment that performs an optical function. As a particular example, the surface B may be a thin film optical element surface formed on the optical element 210-2 to split optical beams into a first portion that is reflected and a second portion that is passed through.

As indicated above, FIGS. 2A-2C are provided as examples. Other examples may differ from what is described with regard to FIGS. 2A-2C.

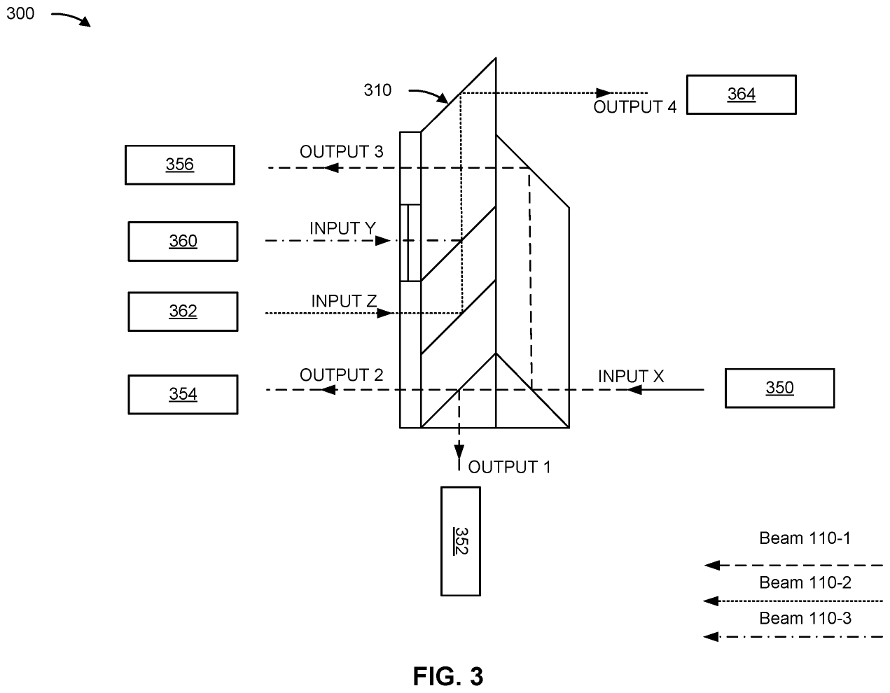

FIG. 3 is a diagram of an example optical system 300 associated with beam splitting and combining micro-optic. As shown in FIG. 3, the optical system 300 includes an optical device 310, which may correspond to the optical device 200. As further shown in FIG. 3, the optical system 300 may include a set of beam sources and/or beam targets. For example, a beam source 350 is aligned to a first input X and directs a beam, via the optical device 310, toward a first output 1, a second output 2, and a third output 3. In this case, the first output 1 is aligned to a beam target 352, the second output 2 is aligned to a beam target 354, and the third output 3 is aligned to a beam target 356. Additionally, or alternatively, the beam source 360 and the beam source 362 are aligned to a second input Y and a third input Z, respectively and direct respective beams, via the optical device 310, toward a fourth output 4 aligned to a beam target 364.

In some implementations, the beam sources 350, 360, 362 may correspond to optical emitters. For example, one or more vertical cavity surface emitting lasers (VCSELs), edge emitting lasers (EELs), laser diodes, or other types of optical emitters may be included in the optical system to transmit optical beams. In this case, the optical device 310 may perform splitting and/or combining of beams from multiple optical emitters. Additionally, or alternatively, the beam sources 350, 360, 362 may correspond to other optical devices, such as other nodes in a communication system. In this case, the optical device 310 may perform optical splitting and/or optical combining to add, drop, or modify beams from a multi-node optical communication system.

As indicated above, FIG. 3 is provided as an example. Other examples may differ from what is described with regard to FIG. 3. The number and arrangement of devices shown in FIG. 3 are provided as an example.

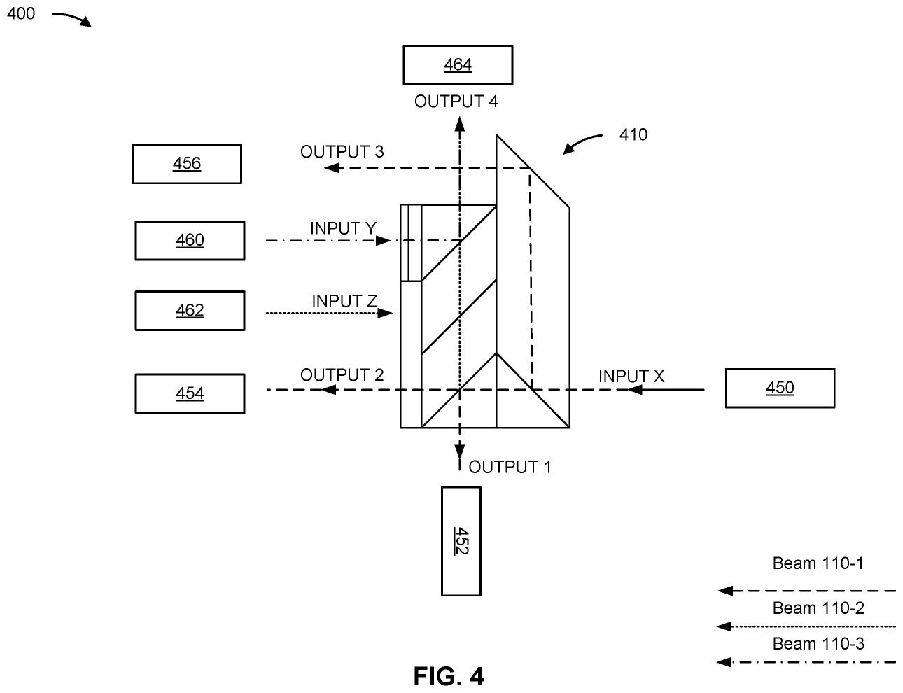

FIG. 4 is a diagram of an example optical system 400 associated with beam splitting and combining micro-optic. As shown in FIG. 3, the optical system 400 includes an optical device 410, which may correspond to the optical device 200. As further shown in FIG. 4, the optical system 400 may include a set of beam sources and/or beam targets. For example, a beam source 450 is aligned to a first input X and directs a beam, via the optical device 410, toward a first output 1 aligned to a beam target 452, a second output 2 aligned to a beam target 454, and a third output 3 aligned to a beam target 456. Additionally, or alternatively, the beam source 460 and the beam source 462 are aligned to a second input Y and a third input Z, respectively, and direct respective beams, via the optical device 410, toward a fourth output 4 aligned to a beam target 464. The optical system 400 includes an alternate configuration in which the output 4 is at a vertical position above the optical device 410, rather than at a horizontal position to the right of the optical device 310 of the optical system 300 shown in FIG. 3. In this case, the beam 110-1, being directed toward the output 3, crosses the combined beams 110-2 and 110-3, being directed toward the output 4, in free space rather than within an optical element, as occurs in, for example, the optical device 310.

As indicated above, FIG. 4 is provided as an example. Other examples may differ from what is described with regard to FIG. 4. The number and arrangement of devices shown in FIG. 4 are provided as an example.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical device, comprising:
a plurality of optically bonded optical elements that form a single monolithic optical component, wherein the plurality of optically bonded optical elements comprises:
a set of optical splitter surfaces configured to optically split a first input beam into a plurality of first output beams; and
a set of optical combiner surfaces configured to optically combine a plurality of second input beams into one or more second output beams,
wherein a set of optical paths coupling a set of inputs, to receive the first input beam and the plurality of second input beams, and the set of outputs, to output the plurality of first output beams and the one or more second output beams, are formed by the single monolithic optical component without an intermediate air interface.

2. The optical device of claim 1, wherein the set of optical paths includes two or more optical paths, wherein each optical path, of the set of optical paths, includes an input of the set of inputs and an output of the set of outputs.

3. The optical device of claim 1, wherein each optical path, of the set of optical paths, traverses two anti-reflectance coatings.

4. The optical device of claim 1, wherein each optical path, of the set of optical paths, is associated with an incidence angle of that is offset from normal.

5. The optical device of claim 1, wherein the plurality of optically bonded optical elements includes at least one thin film.

6. The optical device of claim 1, wherein the plurality of optically bonded optical elements includes at least one interface to divide a beam into a plurality of component beams.

7. The optical device of claim 6, wherein the at least one interface is a surface that passes through a first portion of the beam and reflects a second portion of the beam.

8. The optical device of claim 1, wherein the plurality of optically bonded optical elements is configured to split a single input beam into three output beams associated with three outputs.

9. An optical system, comprising:
an optical device including a plurality of optically bonded optical elements, the plurality of optically bonded optical elements comprising:
a first set of optical elements to optically split a first one or more beams,
wherein the first set of optical elements includes at least one splitting surface and at least one reflecting surface; and
a second set of optical elements to optically combine a second one or more beams,
a set of inputs; and
a set of outputs,
wherein the set of inputs is coupled to the set of outputs via the first set of optical elements and the second set of optical elements.

10. The optical system of claim 9, wherein the second set of optical elements includes at least one polarization dependent reflecting surface and another at least one reflecting surface.

11. The optical system of claim 9, wherein the plurality of optically bonded optical elements, comprises:
a first optical element with a first refractive index, and
a second optical element, with a second refractive index, bonded to the first optical element,
wherein the first refractive index is within a threshold percentage of the second refractive index.

12. The optical system of claim 11, wherein the threshold percentage is less than 5%.

13. The optical system of claim 11, wherein the threshold percentage is less than 1%.

14. The optical system of claim 11, wherein the first optical element and the second optical element are glass optical elements.

15. The optical system of claim 9, wherein the plurality of optically bonded optical elements includes an optical element with a surface treatment.

16. The optical system of claim 15, wherein the surface treatment includes at least one of:
a thin film,
a surface coating,
a patterning, or
an etching.

17. An optical device, comprising:
a plurality of optically bonded optical elements that form a single monolithic optical component, wherein the plurality of optically bonded optical elements comprises:
a set of optical splitter surfaces configured to optically split a first input beam into a plurality of first output beams,
wherein the set of optical splitter surfaces are formed on a first subset of optically bonded optical elements of the plurality of optically bonded optical elements,
wherein the set of optical splitter surfaces includes at least one splitting surface and at least one first reflecting surface; and
a set of optical combiner surfaces configured to optically combine a second input beam and a third input beam into a single second output beam,
wherein the set of optical combiner surfaces are formed on a second subset of optically bonded optical elements of the plurality of optically bonded optical elements,
wherein the set of optical combiner surfaces includes at least one polarization multiplexing surface and at least one second reflecting surface,
wherein the plurality of optically bonded optical elements includes a set of inputs and a set of outputs, and
wherein a set of optical paths coupling the set of inputs and the set of outputs are formed by the single monolithic optical component without an intermediate air interface.

18. The optical device of claim 17, wherein the set of optical splitter surfaces includes an optical element surface with a functional patterning.

19. The optical device of claim 17, wherein the set of optical combiner surfaces includes an optical element surface with a functional patterning.

20. The optical device of claim 17, wherein at least one optical element, of the plurality of optically bonded optical elements, includes both an optical splitter surface, of the set of optical splitter surfaces, and an optical combiner surface, of the set of optical combiner surfaces.
